(19) United States
(12) Patent Application Publication
(10) Pub. No.: US 2006/0185531 A1
(43) Pub. Date: Aug. 24, 2006

(54) Grill pan with adjusting hinge

(75) Inventor: Salvatore J. Torre, Lafayette, NJ (US)

Correspondence Address: DOCKET ADMINISTRATOR;LOWENSTEIN SANDLER PC, 65 LIVINGSTON AVENUE, ROSELAND, NJ, 07068, US

(73) Assignee: Bon Chef, Inc.

(21) Appl. No.: 11/356,772

(22) Filed: Feb. 17, 2006

Related U.S. Application Data
(60) Provisional application No. 60/655,822, filed on Feb. 24, 2005.

(51) Int. Cl. B02B 3/12

(52) U.S. Cl. 99/522

(57) ABSTRACT

A grill pan for grilling food is provided. The grill pan is made of a lid and a base with grill ridges and a slidably adjustable hinge-like mating portion, which allows the lid to freely adjust to various thicknesses of foods placed inside the pan.

### CROSS REFERENCE TO RELATED APPLICATIONS

This application claims benefit of Provisional Application No. 60/655,822, filed on Feb. 24, 2005, entitled “Oven Grill Pan with Adjusting Hinge,” the entire disclosure of which is incorporated herein by reference.

### BACKGROUND OF THE INVENTION

1. Field of the Invention

The present invention relates generally to the field of grilling instruments, and, more particularly, to a two-part grill pan with an adjustable hinge for grilling foods inside of a conventional oven or a convection oven.

2. Related Art

Apparatuses for grilling food are well known and commercially available. Prior art includes grilling devices for use atop a conventional gas or electric range, as well as the famous George Foreman™ grill. Drawbacks of such devices include a dependency on an attached power source or heating element, difficulty in cleaning the device, and typically a small size, which limits the amount of food that may be cooked at one time on the cooking space.

### SUMMARY OF INVENTION

The present invention comprises a two-part grill pan for grilling foods of different thicknesses inside a conventional or convection oven. In an embodiment of the present invention, a grill pan is implemented as a formed heat-conducting metal rectangular base or lower portion supporting a food cooking, or grilling, surface and a formed heat-conducting metal rectangular lid or upper portion to be placed on top of food to be cooked. Preferably, the positions of the base and the lid relative to each other are set by adjustable hinge-like mating portions. The mating portions allow a vertical distance between the base and the lid to be freely adjustable to accommodate foods of various thicknesses. The mating portions prevent the base and the lid from shifting laterally relative to each other

According to one aspect of the present invention, the base comprises an upper portion and a lower portion, where the upper portion is a corrugated grill surface with a plurality of elevated grill ridges, referred to herein as “veins,” disposed at a distance from one another, and grooves, referred to herein as “drain channels,” alternately positioned between the grill veins, which allow grease, juice, and/or other food liquids to drain from the food being grilled. A wall is positioned about the periphery of the base and may be upstanding such that the wall extends above the grill veins of the base. In a preferred embodiment, a front portion of the wall of the base is tall enough to meet a top surface of the lid when the lid lays on the base for storage.

According to another aspect of the present invention, a collecting channel, or grease channel, runs along a lower internal section of the front portion of the wall of the base, and is in fluid communication with the drain channels. In some embodiments, the collecting channel runs along a peripheral edge of the base. The collecting channel has a top edge lower than the top of the front portion of the wall of the base. Advantageously, the grill veins of the base are positioned at a slight downward slope, from a higher elevation at a back portion of the wall of the base to a lower elevation at the front portion of the wall of the base, in order to facilitate the flow of grease, juice, and/or other food liquids from the drain channels into the collecting channel. The collected grease, juice, and/or other food liquids subsequently may be poured readily from the grill pan.

In yet another aspect, the base of the grill pan includes one or more indentations in a portion of the wall. The indentations may extend through the width of the portion of the wall and, advantageously, may be located just above the top edge of the collecting channel inside the front portion of the wall. These indentations allow for one or more lift handles to be hooked onto the upper edge of the collecting channel, which allows a user to lift and move the grill pan without physically touching the grill pan, such as, for example, when the grill pan is placed into or removed from an oven. Advantageously, the lift handles may be made of any sturdy, heat-resistant material including, for example, metal encased in a wooden grip. The lift handles may be fixed to the base of the grill pan or they may be removable.

According to another aspect of the present invention, the lid of the grill pan includes an upper surface and a lower surface, where the lower surface is a corrugated surface with a plurality of grill veins similar to those of the base and disposed at a distance from one another, and with a plurality of drain channels alternately positioned between the grill veins of the lid. The grill veins of the lid extend from a back edge of the lid to a front lip at a front edge of the lid. In a preferred embodiment, the lid is dimensioned smaller than the base such that it may rest within the periphery of the base for storing purposes. Preferably, the lid includes a lid handle, or lid lift lug, positioned at the front lip of the lid. Optionally, the lid handle may be centered along the front lip of the lid or may be in two or more parts positioned in a spaced relationship along the front lip of the lid. The lid handle allows a user to easily lift and lower the lid of the grill pan, either by hand or by one or more of the lift handles. The lid handle may be integrally formed from the material as the lid of the grill pan, or it may be a separate unit that is physically attached to the grill pan lid. Optionally, the lid handle may include an aperture for hooking a lift handle in order to lift the lid to an opened position relative to the base.

In yet another aspect, the lid has indentations in the front lip, and spaced such that the lid indentations line up with the indentations in the base of the grill pan. The lid indentations provide clearance for the lift handles to properly hook onto the top edge of the collecting channel in order to lift and move the grill pan while the lid is resting within the periphery of the base.

In a further aspect of the present invention, the lid of the grill pan is pivotally registered to the base by an adjusting hinge. The adjusting hinge comprises a plurality of lid pivot guide pins, which include outer guide pins that protrude upwards from the back portion of the wall of the base, and inner guide pins that protrude from the upper surface of the base, from a position near a back portion of the wall of the base. The lid pivot guide pins may be positioned substantially perpendicular to the upper surface of the base. Optionally, other configurations of lid pivot guide pins that allow the lid to be pivotally registered to the base are within the scope of the present invention. Positioned along a portion of the wall of the base is a lid stop that allows the lid to rest in an opened position generally upright or perpendicular to the base of the grill pan, while also preventing the lid from falling backwards. Preferably, the lid stop protrudes substantially upward from the back portion of the wall of the base. The lid pivot guide pins and the lid stop may be integrally formed from the same material as the base of the grill pan, or they may be separate units that are welded or attached by other means to the back portion of the wall of the base of the grill pan. Optionally, other configurations of lid pivot guide pins that allow the lid to be pivotally registered to the base are within the scope of the present invention.

In still another aspect of the present embodiment, a portion of the back edge of the lid may be machined smooth into a cylindrical bar portion. At the ends of bar portion, a small portion of the lid is carved out along a short length of the grill veins, producing two slots. To connect the lid to the base, the bar portion slides between the lid pivot guide pins and the two slots fit around the inner guide pins, allowing the lid to lay flat onto the base or within the periphery of the base. The lid pivot pins protrude from the ends of the bar portion of the lid and align the base with the lid. The lid pivot pins also provide stability to the lid when pivotally registered to the base. By not permanently affixing the lid to the base, the lid may adjust freely to the height or thickness of foods placed between the lid and the base, so that the lid lays generally flat on top of foods placed inside the grill pan. Additionally, the lid may be separated completely from the base for cleaning purposes. Accordingly, other configurations of an adjusting hinge are within the scope of the present invention.

Alternatively, the bar portion and lid pivot pins may be integrally formed out of the same material as the lid of the grill pan, or they each may be separate units that are welded or attached by other means to the back edge of the lid of the grill pan.

According to another aspect of the present invention, the grill pan may be made of an uncoated metal in order to produce grill marks on foods placed inside the grill pan. Preferably, the grill pan is made of aluminum, steel, or any other metal of sufficient weight and consistency to provide proper heat conduction. Advantageously, the grill veins and valleys of both the lid and the base may be triangular in shape. However, one of ordinary skill would recognize that other embodiments of the present invention may incorporate grill veins of other functional shapes, such as, for example, rectangular, semi-cylindrical, and trapezoidal.

According to an embodiment of the present invention, a method for grilling foods using the grill pan includes placing food onto the grill veins of the base and lowering the pan lid to rest on the food such that the grill veins of the pan lid rest against the food. The lid adjusts to the thickness of the food via the adjusting hinge and lays flat on top of he food. A user may hook the lift handles onto the collecting channel inside the base of the grill pan, and pick up and place the grill pan inside a conventional oven or, in the alternative, a convection oven, without having to physically touch the grill pan and risk dropping the pan or being burned. The grill pan grills food thoroughly, and, most likely, in an amount of time less than what it would take to cook the food in a conventional oven or a convection oven without using the grill pan. Additionally, the grill pan places grill marks onto the food. Advantageously, the grill pan may prevent food cooked therein from drying out, which is a common drawback of baking or broiling food inside a conventional oven or a convection oven. Once fully cooked, or grilled, the user again may use the lift handles to remove the grill pan from the oven and may use one lift handle to open the lid of the grill pan. Thus, a grilling instrument for use inside a conventional oven or a convection oven is provided. Accordingly, the grilling instrument of the present invention also may be used atop a common barbeque pit, inside a brick-oven, or in conjunction with any other type of indoor or outdoor cooking apparatus.

### BRIEF DESCRIPTION OF THE DRAWINGS

The present invention will be more readily understood from the detailed description of the preferred embodiment(s) presented below considered in conjunction with the attached drawings, of which:

FIG. 1 presents a rear perspective view of a grill pan in a semi-opened position, according to an embodiment of the present invention;

FIG. 2 presents an exploded perspective view of components of a grill pan and a side view of a grill pan, according to an embodiment of the present invention; and

FIGS. 3A and 3B are rear perspective and front perspective views of a grill pan in an opened position, according to an embodiment of the present invention.

### DETAILED DESCRIPTION OF THE INVENTION

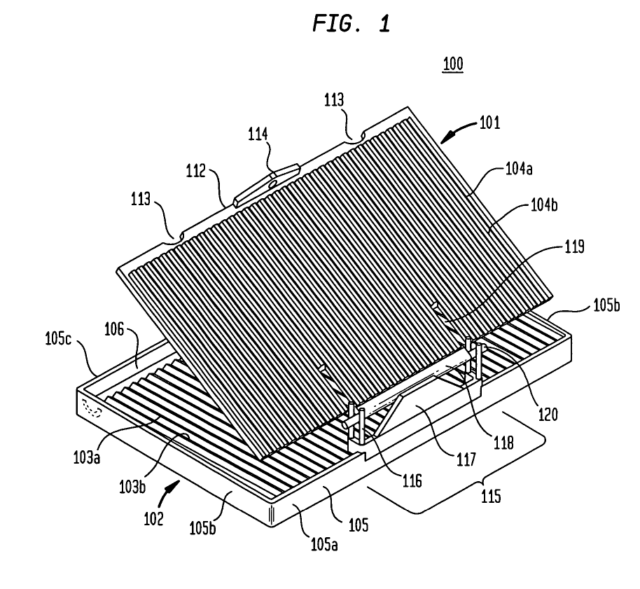

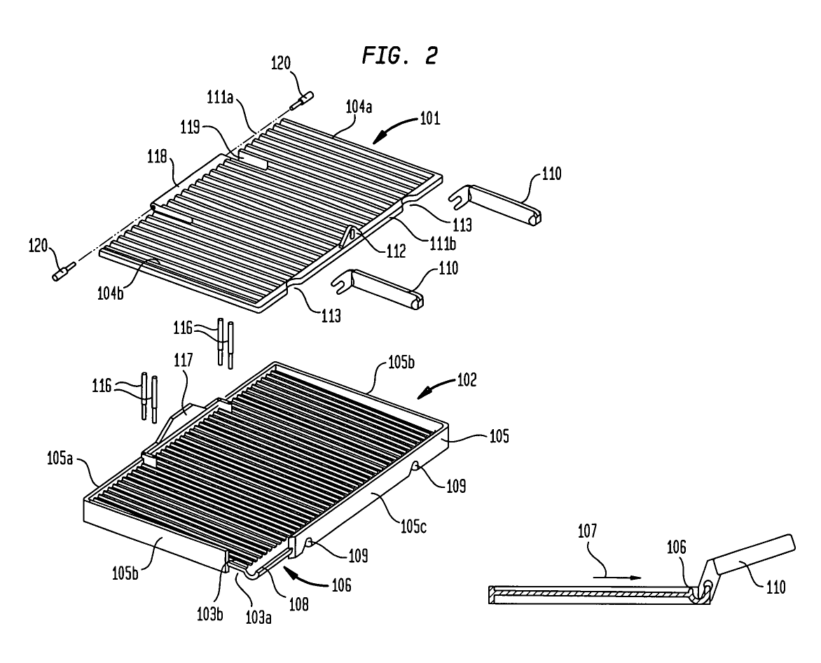

FIG. 1 is discussed in conjunction with FIG. 2. FIG. 1 is a rear perspective view of a grill pan 100 with a base 102 and a lid 101 pivotally registered to the base 102 by an adjusting hinge 115. FIG. 2 presents an exploded perspective view of individual components that make up a grill pan 100 according to an embodiment of the present invention. A base 102 supports a corrugated food cooking surface with grill rods 103a, or grill veins, disposed at a distance from one another, and drain channels 103b, or valleys, alternately positioned between the base grill veins 103a. Similarly, a lid 101 has grill veins 104a disposed at a distance from one another, and channels or valleys 104b alternately positioned between the lid grill veins 104a. Preferably, the lid grill veins 104a are sized and spaced apart such that the lid grill veins 104a rest in an interlocking position with the base grill veins 103a when the lid 101 is placed in a closing position onto the base 102 for nonuse or storing purposes.

In FIGS. 1 and 2, an upstanding wall 105 surrounds the periphery of the base 102 and, advantageously, is of a height greater than the height of the base grill veins 103a. Two side portions 105b of the wall 105 and a back portion 105a of the wall 105 of the base 102 are adjacent to the grill Veins 103a. A front portion 105c of the wall 105, however, is spaced at a distance from the front edges of the grill veins 103a. Within this space is a collecting channel, or grease channel 106, which runs transverse to the base grill veins 103a. The collecting channel 106 provides for collecting grease, juice, and other food liquids, which are produced during a grilling process. As shown in the side section view, in FIG. 2, the base grill veins 103a are positioned at a slight downward slope 107, from a higher elevation at the back portion 105a of the wall 105 of the base 102 to a lower elevation at the front portion 105c of the wall 105 of the base 102, in order to facilitate the flow of food liquids for easy disposal. Grease, juice, and other food liquids may run along the sides of the base grill veins 103a and temporarily collect in the drain channels 103b alternately positioned between the base grill veins 103a. The downward slope 107 of the base grill veins 103a then provides for a natural flow of the grease, juice, and other food liquids into the collecting channel 106, where it keeps until the grill pan 100 is removed from a conventional oven, or a convection oven. Although FIGS. 1-5 present a rectangular base 102 and a rectangular lid 101, the grill pan 100 of the present invention may have other shapes, including circular, oval, and polygonal shapes.

As shown in FIG. 2, the collecting channel 106 has a top edge 108, which is lower than the top edge of the front portion 105c of the wall 105 of the base 102. Two indents 109 are positioned on the front portion 105c of the wall 105 of the base 102, above the upper edge 108 of the collecting channel 106. The indents 109 extend through the width of the front portion 105c of the wall 105 and allow for lift handles 110 to be hooked onto the upper edge 108 of the collecting channel 106, allowing a user to lift and move the grill pan 100 without physically touching the grill pan 100, which may be heated to oven temperatures. Thus, a user may use the grill pan 100 safely without the worry of being burned and/or spilling food liquids from the grill pan 100, which may be messy and dangerously hot.

Preferably, the lift handles 110 are made of a material that is able to withstand high temperatures, able to bear a heavy weight load, and is a poor heat conductor. For example, the lift handles 110 made be made of metal encased in wood or any other material capable of withstanding high temperatures and preventing heat conduction. According to a preferred embodiment, a portion of the lift handle 110 used to hook onto a grill pan 100 may comprise two metal prongs, formed generally parallel to one another and shaped such that the prongs provide a secure fit onto the grill pan 100. The two prongs may be machined in a bent or angled position with respect to the remaining portion of the lift handle 110, as shown in FIG. 2, however, one of ordinary skill would recognize that the lift handles 110 of the present invention may be formed into multiple configurations and still perform their necessary function.

A lid 101 of the grill pan 100 includes grill veins 104a similar to the base grill veins 103a and disposed at a distance from one another, with channels 104b alternately positioned between each grill vein 104a. The lid grill veins 104a extend from a back edge 111a of the lid 101 to a front lip at a front edge 111b of the lid 101. The front lip provides a surface area for a lid lift lug 112, or lid handle, and two indents 113 or grooves, which serve as clearance grooves for the lift handles 110. The lid handle 112 may be positioned in the center of the front lip of the lid 101, as shown in FIG. 2, and may be integrally formed from the same material as the lid 101 of the grill pan 100, or it may be a separate attachment. Optionally, the lid handle 112 may have an aperture 114 for hooking the lift handle 110 onto the lid handle 112 in order to lift the lid 101 to an opened position relative to the base 102.

As shown in FIGS. 1 and 2, the clearance grooves 113 in the front lip of the lid 101 are positioned such that the clearance grooves 113 line up with the indents 109 in the front portion 105c of the wall 105 of the base 102. The clearance grooves 113 prevent the lid 101 from inhibiting the lift handles 110 ability to hook onto the top edge 108 of the collecting channel 108 when the lid 101 is in a closed or flat position, relative to the base 102.

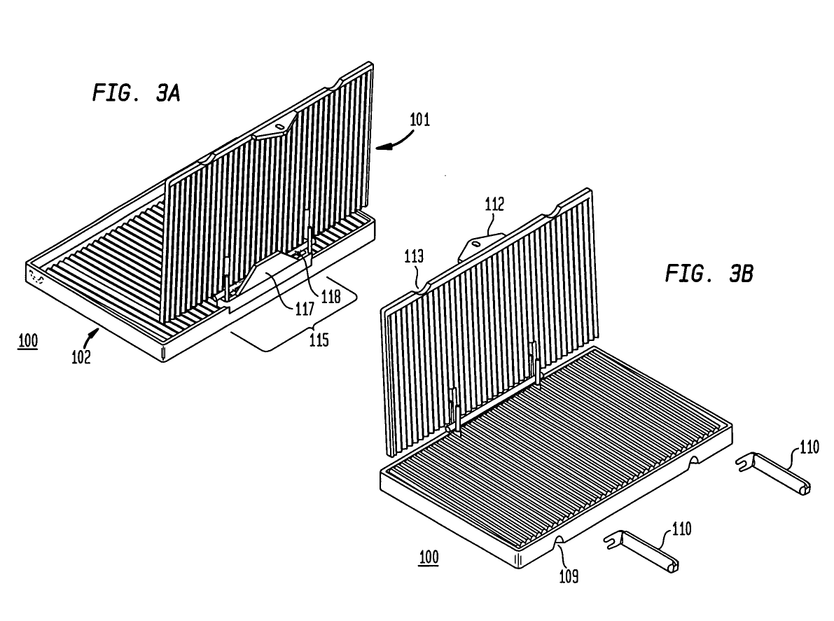

The lid 101 of the grill pan 100 is pivotally registered to the base 102 via an 115 adjusting hinge, as shown in FIGS. 1 and 3A-3B, where FIGS. 3A and 3B. In a preferred embodiment, the adjusting hinge 115 includes a plurality of lid pivot guide pins 116, as shown in FIGS. 1 and 2, which protrude upwards from the back portion 105a of the wall 105 of the base 102 and from a location inside the base 102, where the location is disposed at a distance from the back portion 105a of the wall 105 of the base 102. The plurality of lid pivot guide pins 116, as shown in FIG. 2, may be separate units that are attached to the base 102, or may be integrally formed from the same material as the base 102. The plurality of lid pivot guide pins 116 may include outer lid pivot guide pins, which are located along the back portion 105a of the wall 105 of the base 102, and inner lid pivot guide pins, which are positioned at a relatively short distance from the outer lid pivot guide pins, as shown in FIG. 2. The lid pivot guide pins 116 may be positioned generally perpendicular to the base grill veins 103a, as shown in FIGS. 1 and 2. Alternately, other configurations of lid pivot guide pins 116 that allow the lid 101 to be pivotally registered to the base 102 are within the scope of the present invention.

As shown in FIGS. 1 and 2, a lid stop 117 is positioned between the two outer lid pivot guide pins 116, and protrudes generally upward from the back portion 105a of the wall 105 of the base 102 and generally perpendicular to the grilling surface. The lid stop 117 permits the lid 101 to rest in an opened position generally upright or perpendicular to the base 102 of the grill pan 100, and also prevents the lid 101 from falling backwards when in the opened position.

As shown in FIGS. 1 and 2, a portion of the back edge of the lid 101 is formed into a smooth cylindrical edge, or bar portion 118, and when the lid 101 is registered to the base 102, the bar portion 118 is positioned between the lid pivot guide pins 116 of the base 102, such that it “slides” between the lid pivot guide pins 116. Adjacent to the bar portion 118 is one or more hinge slots 119 carved into the lid 101 of the grill pan 100, and are positioned generally parallel to the lid grill veins 104a and generally perpendicular to the bar portion 118. The bar portion 118 and the hinge slots 119 register the lid 101 to the base 102 with the bar portion 118 sliding between the outer and inner lid pivot guide pins 116 while the hinge slots 119 fit around the lid pivot guide pins 116. To align the base 101 with the lid 102, a lid pivot pin or bolt 120 may be attached to each outer end of the bar portion 118 of the lid 101 such that the lid pivot bolts 120 extend beyond the total length of the back portion of the wall 105 of the base 102 from one outer lid pivot guide pin 116 to the other outer lid pivot guide pin 116. Alternately, the lid pivot bolts 120 may be integrally formed from the same material as the lid 101 instead of being separate units for attachment.

The adjusting hinge 115 allows the lid to move freely with respect to the base of the grill pan 100. When food is placed onto the grill surface of the base 102, the lid 101 adjusts to the height or thickness of the food and may lie generally flat on top of the food instead of at an angle. With the lid 101 lying generally flat, the grill pan 100 is easily placed into a conventional oven or a convection oven. Additionally, a greater surface area of the lid 101 comes into contact with the food. Advantageously, the lid 101 may be separated completely from the base 102 in order to be cleaned.

FIG. 3A is a rear perspective view of a grill pan 100, according to an embodiment of the present invention, with a lid 101 of the grill pan 100 placed in an opened position. As shown in both FIGS. 3A and 3B, the lid 101 is pivotally registered to a base 102 of the grill pan 100 by an adjusting hinge 115 with a bar portion resting 118 between a plurality of lid pivot guide pins 116, similar to FIG. 1. The lid 101 rests against a lid stop 117, which permits the lid to rest in an open position generally perpendicular to the base 102. FIG. 3B is a front perspective view of the same grill pan 100.

FIG. 3 is a perspective view of a grill pan, according to an embodiment of the present invention, in a closed position while not in use. In this embodiment, a lid stop runs a length of a back portion of the wall portion between two lid pivot guide pins, and both the lid stop and the lid pivot guide pins are integrally formed from the same material as the base of the grill pan. Additionally, slots carved into the lid are shown in greater detail.

As will be appreciated, there are countless configurations for a grill pan that grills foods inside a conventional or convection oven. FIGS. 1-7 illustrate only a few possible configurations, and in no way should be construed as limiting the application of the inventive apparatus to those configurations. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A grill pan for grilling food of various thicknesses comprising:
a heat-conducting base for grilling food, having an upper surface and a lower surface;
a heat-conducting lid having an upper surface and a lower surface for placing on top of the food; and
a slidably adjustable hinge for retaining the lid in substantially horizontal alignment with the base during use, wherein the slidably adjustable hinge permits the lid to move vertically with respect to the base to accommodate grilling foods of various thicknesses.

2. The grill pan of claim 1, wherein the upper surface of the base comprises a plurality of alternating ridges and grooves.

3. The grill pan of claim 1, wherein the base comprises a wall positioned about a periphery of the base.

4. The apparatus of claim 3, wherein the wall retains food liquids that drain from food being grilled.

5. The grill pan of claim 2, wherein the base further comprises a collecting channel, wherein the collecting channel is in fluid communication with the plurality of grooves.

6. The grill pan of claim 5, wherein the plurality of grooves are sloped downwardly toward the collecting channel to facilitate the drainage of food liquid during grilling.

7. The grill pan of claim 1, wherein the base further comprises a collecting channel, wherein the collecting channel runs along a peripheral edge of the base.

8. The grill pan of claim 2, wherein the base further comprises a wall positioned about a periphery of the base

9. The grill pan of claim 8, wherein the base further comprises at least one indentation in a portion of the wall.

10. The grill pan of claim 9, wherein the at least one indentation extends through a width of the portion of the wall.

11. The grill pan of claim 9, further comprising at least one lift handle, wherein the at least one lift handle is adapted to attach to the at least one indentation to permit a user to lift and move the apparatus.

12. The grill pan of claim 11, wherein the at least one lift handle is adapted to removably attach to the at least one indentation.

13. The grill pan of claim 11, wherein the at least one lift handle is fixed to the at least one indentation.

14. The grill pan of claim 11, wherein the at least one lift handle is made of a heat-resistant material.

15. The grill pan of claim 1, wherein the base further comprises a wall positioned about a periphery of the base.

16. The grill pan of claim 15, wherein the base further comprises at least one indentation in a portion of the wall.

17. The grill pan of claim 16, wherein the at least one indentation extends through a width of the portion of the wall.

18. The grill pan of claim 16, further comprising at least one removable lift handle, wherein the at least one removable lift handle is adapted to removably attach to the at least one indentation to permit a user to lift and move the apparatus.

19. The grill pan of claim 18, wherein the at least one lift handle is made of a heat-resistant material.

20. The grill pan of claim 1, wherein the lower surface of the lid comprises a plurality of alternating ridges and grooves.

21. The grill pan of claim 1, wherein the lid is dimensioned so that it may be placed within a periphery of the base for storing.

22. The grill pan of claim 1, wherein the adjustable hinge comprises a plurality of lid pivot guide pins protruding from and substantially perpendicular to the upper surface of the base to permit pivotal registration of the lid to the base.

23. The grill pan of claim 22, wherein the plurality of lid pivot guide pins permits the lid to be move freely from a closed position that is substantially parallel with the base to an open position that is substantially perpendicular with the base.

24. The grill pan of claim 23, wherein the base further comprises at least one lid stop, wherein the lid stop allows the lid to rest in the open position and prevents the lid from falling into the closed position.

25. The grill pan of claim 22, wherein the adjustable hinge further comprises at least one lid pivot bolt protruding from the lid, wherein the at least one lid pivot bolt is adapted to slidably engage with the plurality of lid pivot guide pins.

26. The grill pan of claim 1, wherein the base and the lid comprise a heat-conducting metal.

27. The grill pan of claim 26, wherein the heat-conducting metal is selected from the group consisting of aluminum, steel, and iron.

28. The grill pan for grilling food of various thicknesses comprising:
a heat-conducting base for grilling food, having an upper surface and a lower surface,
wherein the upper surface of the base comprises:
a plurality of alternating ridges and grooves;
a wall positioned about a periphery of the base;
a collecting channel that is in fluid communication with the plurality of grooves; and
at least one indentation in a portion of the wall;
at least one removable lift handle that is adapted to removably attach to the at least one indentation;
a heat-conducting lid having an upper surface and a lower surface for placing on top of the food, wherein the lid is dimensioned so that it may be placed within the periphery of the base, and wherein the bottom surface of the lid comprises a plurality of alternating ridges and grooves; and
a slidably adjustable hinge for retaining the lid in substantially horizontal alignment with the base during use, wherein the slidably adjustable hinge permits the lid to move vertically with respect to the base to accommodate grilling foods of various thicknesses, and wherein the slidably adjustable hinge comprises a plurality of lid pivot guide pins protruding from and substantially perpendicular to the upper surface of the base to permit pivotal registration of the lid to the base, and at least one lid pivot bolt adapted to slidably engage with the plurality of lid pivot guide pins.

29. A grill pan for grilling food of various thicknesses inside a conventional or convection oven comprising:
a heat-conducting base for grilling food, having an upper surface and a lower surface;
a heat-conducting lid having an upper surface and a lower surface for placing on top of the food; and
a hinge connecting the lid to the base.
